(19) United States
(12) Patent Application Publication
(10) Pub. No.: US 2007/0201749 A1
(43) Pub. Date: Aug. 30, 2007

(54) Image Processing Device And Image Processing Method

(76) Inventors: Masaki Yamauchi, Osaka (JP); Masayuki Kimura, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/547,643

(22) PCT Filed: Feb. 7, 2006
(86) PCT No.: PCT/JP06/02059

§ 371 Date: Oct. 5, 2006

(30) Foreign Application Priority Data
Feb. 7, 2005 (JP) 2005-031113

(51) Int. Cl. G06K 9/62

(52) U.S. Cl. 382/225

(57) ABSTRACT

An image processing device and the like capable of extracting an ROI conforming to a user's request is provided when extracting an ROI from an image.

Image processing necessary to calculate the attractiveness of each position (pixel) in the image is performed on an original image inputted from an image input unit (102) by an image processing device for calculating the attractiveness (124), and the attractiveness of each position is calculated by the attractiveness calculating unit (122). A region forming unit (144) determines an ROI based on the attractiveness of each position, and a region forming condition setting unit (142) designates the determining condition therein. When the region forming condition setting unit (142) sets an ROI determining condition, this condition is set based on user's instructions inputted from respective designating units (112 to 118). Each output unit (an image output unit (152), a status output unit (154), and a region information output unit (156)) outputs a processed image, a processing status and information about an ROI (coordinates and size).

### TECHNICAL FIELD

The present invention relates to an extraction technology of a region of interest in an image, and particularly relates to a technology for extracting a region of interest according to a user's request.

### BACKGROUND ART

Generally, an image is often divided into interesting (or important) regions (hereinafter referred to as “ROI: Region of Interest”) and other regions. The image processing (e.g. enlargement and high definition) is often performed on the ROIs.

Various approaches and methods for extracting ROIs from an image have hitherto been proposed (e.g. see Non-Patent References 1 and 2).

However, conventional technologies of extracting and utilizing ROIs have a problem in that it is impossible to adequately reflect users' requests in extracting ROIs. In other words, although conventional technologies allow ROIs to be extracted from an image, such extraction is only performed based on a predetermined algorithm (e.g. the attractiveness calculation formula) and attributes (e.g. shape, size, position, and the number of regions) of ROIs to be extracted are not considered, and thus these technologies are not capable of extracting ROIs that a user desires.

In the aforementioned Non-Patent Reference 1, although a position of the user's attention (which is equivalent to a position of the ROI since it can be considered as a position in the image at which the user stays looking or gazes) is extracted from a multi-resolution model (a stepwise expression of image resolution by a pyramid structure), there is no description regarding a range of the user's attention (which is equivalent to the ROI).

In this case, an octagonal ROI cannot be extracted even when the user has a specific request regarding a shape of the ROI (e.g. an octagonal ROI). Only the position of the ROI is extractable (in the aforementioned Non-Patent Reference 1, the size of the range of the user's attention is fixed).

In comparison with the approach of the Non-Patent Reference 1, the range of the user's attention is described in the aforementioned Non-Patent Reference 2. In the case of the Non-Patent Reference 2, while the specific visual model is prepared for the size of the user's attention range based on a scale space, the position and the user's attention range depends only on a target image from which the ROIs are to be extracted. That is, as in the Non-Patent Reference 1, the problem remains that the user's request cannot be fulfilled. In other words, for multiple image inputs, it is impossible to extract the same size, same shape and same number of the ROI. The size, shape and number of the ROI are determined specifically based on the predetermined algorithm, and the number, shape and the like of the ROI to be extracted generally vary. The automatic extraction of the ROI is disclosed in several papers and the like besides the aforementioned Non-Patent Reference 1 and the Non-Patent Reference 2. There is also a proposed method for automatically extracting ROIs by using the JPEG 2000 data structure (e.g. see the Non-Patent Reference 3).

In the case of the Non-Patent Reference 3, however, the position and size of the ROI to be extracted depend on an image alone. It is obvious that such dependency becomes a significant problem in practical application. Even when “the creation of a human gaze model based on a sight model” in the Non-Patent Reference 3 is utilized in an actual extraction of the ROI, this method has less utility value because what is obtained is uncontrollable. A method for extracting the ROI useful for actual applications must be capable of reflecting the user's intentions and instructions appropriately.

Meanwhile, a method for selectively extracting the ROI based on the instructions inputted by the user or the like has also been disclosed. For example, there are following types of instructional information obtained from a user or the like: the information regarding an object, such as “the portion with the object's face” or “the region closer to the user”, and the information regarding the attributes of the image such as the impressions (characteristics) of the image that are the “reddish region” and the “conspicuous region”. There is also a case in which one of the following types of information is received as an instructional input: the information regarding a display method for the number, size or shape of the ROI to be extracted, or the information regarding processing required by the user, such as to “create a thumbnail image (panned version of the image for a list display) from traveling photographs” and to “cut out only a section a person is captured”.

However, these are basically alterations of a formula for calculating an attractiveness (or a conspicuity value) in an image according to the instruction by a user or the like. For example, when a user says “red” (the instruction of “red”), a formula for an attractiveness is altered to increase the attractiveness of the “red” region in the image, so that the red region is altered to show a high score. Similarly, when the user says “human” (the instruction of “human”), the formula of the attractiveness is altered to show a high attractiveness of the region in which a “human”-like object is captured.

Non-Patent Reference 1: “A Saliency-Based Search Mechanism For Over And Covert Shifts Of Visual Attention” (Itti et al., Vision Research, Vol. 40, 2000, pp 1489-1506)

Non-Patent Reference 2: “A Model of Overt Visual Attention Based on Scale-Space Theory” (Trans. Inst. Electron. Inform. Communi. Engnr. Jpn., D-11, Vol. J86-D-II, No. 10, pp 1490-1501, October. 2003)

Non-Patent Reference 3: “Automatic extraction and evaluation of the Region of Interest for JPEG 2000 Transcoder” Takeo Ogita et al., the 30th Media Computing Conference, No. 10, pp. 115-116, June 2002.

### DISCLOSURE OF INVENTION

Problems that Invention is to Solve

Although these methods are very effective in the case where it is already known what is captured and in what way, they cannot sufficiently cope with the case where the number, size and shape of the ROI are desired to be adaptively extracted to match the content of the image.

For example, the conventional methods are not applicable to the following requests: “extraction of a region with, if possible, red objects” and “extraction of two (or more) objects” (applicable degree of these methods is limited to selection of the two reddest points and determination of the peripheral regions of the two points as ROIs). Even in the extraction of the ROI when one of the number, size and shape of the ROI is simply designated by a user (e.g. in the case where to “extract two regions” or to “extract circular regions” is instructed , and where the content of the image such as “red region” is not specified), the conventional methods are either utterly useless or limited to select only the specified number of points with the highest attractiveness in the image and to output the selected points as a designated shape such as a circle or a rectangle.

As described above, the conventional technologies are not applicable to extract the ROI by adaptively interpreting an instruction from a user according to the content of an image.

An object of the present invention is to provide an image processing device capable of extracting an ROI according to a user's request when extracting the ROI from the image.

Means to Solve the Problems

To solve the problem described above, an image processing device according to the present invention includes an image input unit for obtaining image data representing an image, an instruction input unit for receiving a condition of extracting a region of interest (ROI) of the image, an attractiveness for calculating an; attractiveness which indicates a degree of user's attention, a region forming unit for forming an ROI from the image based on a pixel which corresponds to an attractiveness exceeding a predetermined threshold value of the calculated attractiveness, and a determining unit for determining whether or not the formed ROI satisfies the received condition; and in the case where it is determined that the condition is not satisfied, the threshold value is altered, and the processes of the region forming unit and determining unit are repeated.

This allows an extraction of an ROI conforming to a user's request because another ROI is formed by altering a threshold value of the attractiveness in the case where the ROI, formed based on the attractiveness, does not satisfies the received condition.

An image processing device according to the present invention is also capable of receiving the number, shape, size, position and the extraction range of the ROIs as conditions regarding the extraction of the ROI. In addition, this image processing device is capable of adding all kinds of weights (such as a weight based on probability distribution of the designated range, a weight according to the distance from the contour line, and a weight according to the distance from the designated position).

This allows the detailed user request to be reflected by satisfying the conditions such as the number, shape, size, position and the extraction range of the received ROI, when the ROI is extracted from the image.

The aforementioned region forming unit is characterized by changing the number of the image data subjected to the clustering described above, by altering the threshold value.

This facilitates the extraction of the ROI satisfying the condition instructed by the instruction input unit because the number of the image data (the data included in the target population for clustering) to be subjected to clustering can be changed when the ROI is extracted.

The aforementioned region forming unit may further alter the threshold value based on the number of clusters resulting from the clustering described above. The region forming unit is also capable of deciding the threshold value of the attractiveness for extracting the ROI satisfying the conditions instructed by the instruction input unit (satisfying the output condition) through interpolating or extrapolating with the use of a plurality of the number of the created clusters.

Since this allows the threshold value of the attractiveness to be efficiently set without performing one by one setting, the ROI conforming to the user's request can be formed more quickly.

An image processing device according to the present invention may extract edges or objects, calculate the attractiveness based on the result of the extraction. In addition, the image processing device according to the present invention may determine the degree of which the object appears to be itself (the degree of being the object itself) by using pattern-matching or a neural net and, based on the result, may calculate the attractiveness. Further, an image processing device according to the present invention may calculate the attractiveness by adding “a weight corresponding to the types of the object” to “the degree of being the object”. Furthermore, an image processing device according to the present invention may calculate the attractiveness based on a human gaze model.

The features described above realizes the extraction of the ROIs conforming to the user's request in the matter more agreeable to the feeling of humans.

An image processing device according to the present invention may form a region with a higher attractiveness in the image than the predetermined (threshold) value as the ROI, or may form the ROI by performing clustering based on the attractiveness of the region (position), which is higher than the predetermined value (threshold), and the characteristics of the input image (such as texture and contrast/color). Furthermore, clustering may be performed to a plurality of threshold values and a second clustering region including a region determined as the ROI in the first clustering can be formed as an ROI.

This realizes the extraction of an ROI more closely conforming to a user's request.

An image processing device according to the present invention is also capable of outputting a status information of indicating inextractable, when deciding that the ROI conforming to the designated condition cannot be created. In addition, the image processing device according to the present invention is capable of outputting arbitrary status information that indicates the progress and a state of processing.

Accordingly, an output more strictly conforming to a user's request can be performed when the image processing device extracts an ROI.

An image processing device according to the present invention is capable of forming ROIs without overlapping a first ROI with a second ROI or to make the first ROI include the second ROI. An image processing device according to the present invention is capable of forming ROIs in nearly identical size. An image processing device according to the present invention is capable of forming ROIs in various sizes.

This configuration allows the image processing device to extract the ROI more closely conforming to a user's request when the processing device extracts the ROI.

In addition, an image processing device according to the present invention is also capable of outputting the clusters obtained by performing clustering in which the number of clusters is controlled to satisfy the ROI creating condition with regard to the attractiveness. Further, as a method to control the number of clusters, the number of clusters can be controlled by increasing/decreasing a threshold value equivalent to the height of contour line so as to include the regions with attractivenesses higher than the threshold value (just as drawing the contour lines on a map) based on the distribution of the attractivenesses in the image. Furthermore, the predetermined number of clusters can be extracted by repeating the following procedure: “extracting a rough shape of an object in the peripheral region corresponding to the portion with the highest attractiveness; searching for the portion with the second highest attractiveness from a region which is not included in the object region; then extracting the rough shape of an object in the peripheral region corresponding to the portion with the second highest attractiveness”.

This configuration allows the image processing device to extract the ROI which is based more on the content of the image, when the image processing device extracts the ROI.

The present invention can be realized as an image processing method including characteristic constituting units in the aforementioned image processing device as steps, as well as programs for allowing a personal computer and the like to execute these steps or as an integrated circuit. It is obvious that such a program can be widely distributed via a recording medium such as a DVD and a transmission medium including the Internet.

Effects of the Invention

The present invention can be realized to extract the ROI conforming to a user's request (a request regarding the attributes of the ROI, which for example includes shape, size, position and the number of the ROIs) while taking the content and characteristics of the image into consideration.

### BRIEF DESCRIPTION OF DRAWINGS

FIG. 1 is a block diagram showing the function configuration of an image processing device according to the embodiment.

FIG. 2A shows an example of an original image.

FIG. 2B is a schematic diagram in which a multiple resolution image is shown as a mosaic image.

FIG. 3 is a schematic diagram in which edge detection is performed on a mosaic image.

FIG. 4A is an example of an original image.

FIG. 4B is a schematic diagram in which a multiple resolution image is shown as a mosaic image.

FIG. 5A and FIG. 5B are schematic diagrams in which extraction examples are shown when the shape and size of a region to be extracted are specified.

FIG. 6A and FIG. 6B are schematic diagrams in which a weight distribution and extraction examples are shown when the position of a region to be extracted is specified.

FIG. 7A is an example of an original image.

FIG. 7B is a diagram that shows an example of an extracted ROI.

FIG. 8A and FIG. 8B are diagrams each of which shows an example of an extracted ROI.

FIG. 9A and FIG. 9B are diagrams schematically showing examples of mosaic images.

FIG. 10A and FIG. 10B are diagrams schematically showing examples of edge images.

FIG. 11 is a diagram three-dimensionally and schematically showing an attractiveness map and the ROI.

FIG. 12 is a diagram three-dimensionally and schematically showing an attractiveness map and the ROI.

FIG. 13 is a diagram schematically showing an attractiveness map and the ROI.

FIG. 14 is a flowchart showing a flow of processing of an image processing device of the present invention.

FIG. 15A to FIG. 15D are two-dimensional schematic diagrams, each of which shows a relationship between data distribution, threshold values targeted for clustering and the created clusters.

FIG. 16 is a diagram one-dimensionally showing the relationship between distribution of the attractiveness, thresholds and the created clusters from another point of view.

FIG. 17 is an example of a graph showing the relationship between thresholds and the number of the created clusters.

### NUMERICAL REFERENCES

100 Image processing device

102 Image input unit

112 Shape designating unit

114 Size designating unit

116 Position range designating unit

118 Number designating unit

122 Attractiveness calculating unit

124 Image processing unit for calculating the attractiveness

132 Status displaying unit

142 Region forming condition setting unit

144 Region forming unit

146 Clustering unit

147 Threshold value determining unit

148 Attractiveness map unit

152 Image output unit

154 Status output unit

156 Region information output unit

200 Original image

202 Mosaic image

300 Edge detecting image

400 Original image

410 Object A

412 Object B

414 Object C

416 Object D

440 Edge image (attractiveness map)

500 Original image

502 Size example A

504 Size example B

506 Variation allowable width

542 ROI determination example A

544 ROI determination example B

600 Weight setting

612 Weight A region

614 Weight B region

616 Weight C region

618 Weight D region

620 Weighted central value

640 Weighted edge image

642 Circular region

702 ROI extraction image

800 Original image

812 ROI

813 ROI

814 ROI

815 ROI

816 ROI

817 ROI

822 ROI

824 ROI

900 Mosaic image A

910 Mosaic image B

1000 Edge image A

1010 Edge image B

1100 Attractiveness map

1110 ROI

1200 Attractiveness map

1210 ROI

1220 ROI

1302 Threshold value A

1304 Threshold value B

1306 Threshold value C

1310 Scanning line

1601 Conventional ROI

1611-1614 Cluster B

1612, 1622 Cluster A

1701 Point A

1702 Point B

1703 Point C

### BEST MODE FOR CARRYING OUT THE INVENTION

The embodiment of the present invention is explained below referring to diagrams. Although the present invention is explained using the embodiment and attached diagrams, these are only intended to examples and it is not intended that the present invention be limited to the embodiment of the present invention and attached diagrams.

### First Embodiment

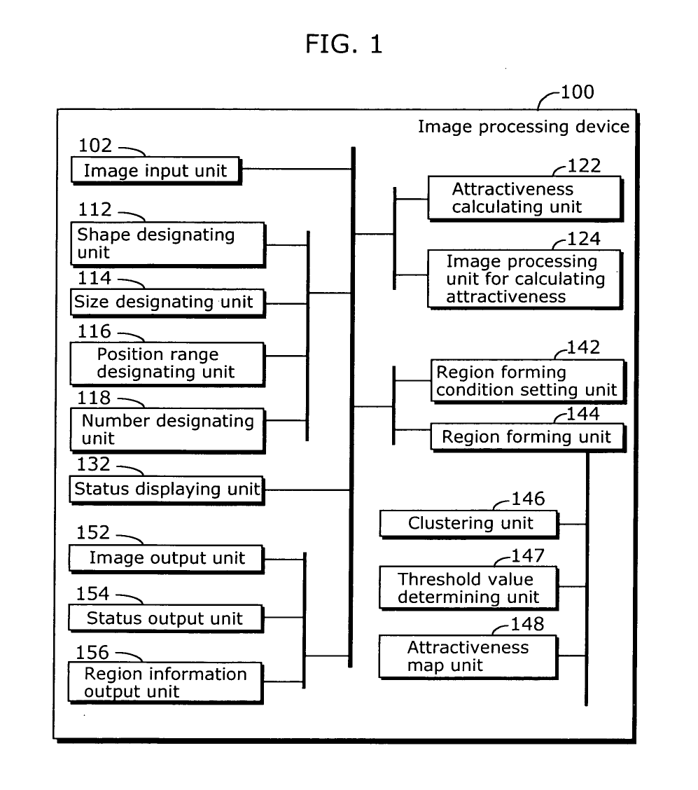

FIG. 1 is a block diagram showing the functional configuration of an image processing device 100 according to the first embodiment of the present invention.

As shown in FIG. 1, the image processing device 100 is a device provided as a part of function of a separate device, a mobile terminal or the like which is capable of extracting the ROI conforming a user's request while considering the content and characteristics of the image. The image processing device includes an image input unit 102, a shape designating unit 112, a size designating unit 114, a position range designating unit 116, a number designating unit 118, an attractiveness calculating unit 122, an image processing unit for calculating the attractiveness 124, a status displaying unit 132, a region forming condition setting unit 142, a region forming unit 144, a clustering unit 146, a threshold value determining unit 147, an attractiveness map unit 148, an image output unit 152, a status output unit 154 and a region information output unit 156.

The image input unit 102 is equipped with a storage device such as a RAM and stores an original image (e.g. an image captured by a digital camera). The image processing unit for calculating the attractiveness 124 performs image processing necessary for calculating the attractiveness (also called “the degree of attention” or “conspicuity value”) of each position within the image. The attractiveness calculating unit 122 actually calculates the attractiveness of each position. The attractiveness described here means the degree of user's attention to a part of the image (and is, for example, expressed by a real number from 0 to 1, or an integer from 0 to 255 and so on).

The status displaying unit 132 is, for example a liquid crystal panel that displays a series of processing details. The image output unit 152, status output unit 154, and region information output unit 156 output a processed image, a processing status and information of the ROI (e.g. coordinates and size) into the status displaying unit 132 or an external display device and the like.

The region forming condition setting unit 142 sets an ROI determining condition, which is the condition for determining an ROI in the region forming unit 144, based on the instructions and conditions received from a user or the like through each designating unit (the shape designating unit 112, the size designating unit 114, the position range designating unit 116 and the number designating unit 118). It should be noted that the region forming condition setting unit is an example of region forming unit.

The region forming unit 144 is a micro-computer equipped with a ROM and the like which store, for example, a RAM and a control program, and controls the entire image processing device 100. Furthermore, the region forming unit 144 forms the ROI based on the attractiveness of each pixel. Note that the region forming unit 144 is equipped with the clustering unit 146, threshold value determining unit 147 and attractiveness map unit 148.

The attractiveness map unit 148 forms an attractiveness map (this is explained later) in which attractivenesses calculated for each image are associated with their positions on the XY-coordinates. The attractiveness map is equivalent to a map on which a brightness value of each pixel is replaced with an attractiveness. In the case where an attractiveness is defined by a block with arbitrary size (n×m pixel: n and m are positive integers), all pixels in each block can be considered having the same attractiveness (or being processed with multiple resolution decomposition and shaped into pyramid).

The clustering unit 146 performs clustering on the aforementioned attractiveness map according to the distribution of attractivenesses. The clustering described here means to group the similar image data (or similar image patterns) into a same class. Clustering methods include hierarchical methods such as a nearest neighbor method, which is designed to put image data and the like being close to each others into one group, and partitioning-optimization such as a k-average method. Although the clustering methods are also described later, the basic operation of clustering methods constitutes dividing the attractiveness map into several clusters (also called “segments” or “categories”) based on the distribution of attractivenesses. Also, clustering is a method to put similar elements into one group, and is defined as “division of a set to be classified” (in this case, this is a set of points at which each attractiveness on the attractiveness map is defined) into a subset in which “internal cohesion” and “external isolation” can be achieved (in this case, the subset is a group of points at each of which an attractiveness is defined). Here, the subsets, into which the attractiveness map is divided or classified are called “clusters”, in the case where the attractiveness map is decided to be a set for classification. For example, in the case where the attractivenesses are locally present at four locations on the attractiveness map, the clustering is equivalent to dividing these attractivenesses into four categories.

The threshold value determining unit 147 controls threshold values when the attractiveness is determined on the attractiveness map. Specifically, in the case where the number, size and the like of clusters which have been divided by the clustering unit 146 do not satisfies the conditions received from a user or the like, the threshold value determining unit 147 increases/decreases the threshold values. Note that the threshold value determining unit is an example of a determining unit.

The detailed functions of each designating unit (e.g. the shape designating unit 112, size designating unit 114, position range designating unit 116 and number designating unit 118) are explained below. An input to the aforementioned each designating unit can be done either by a user or through a control program and the like.

The shape designating unit 112, size designating unit 114, position range designating unit 116 and number designating unit 118 are equipped with a keyboard and a mouse (or through the execution of a control program) receive conditions and instructions to extract the ROI from a user or the like. The shape designating unit, size designating unit, position range designating unit and number designating unit are examples of an instruction input unit.

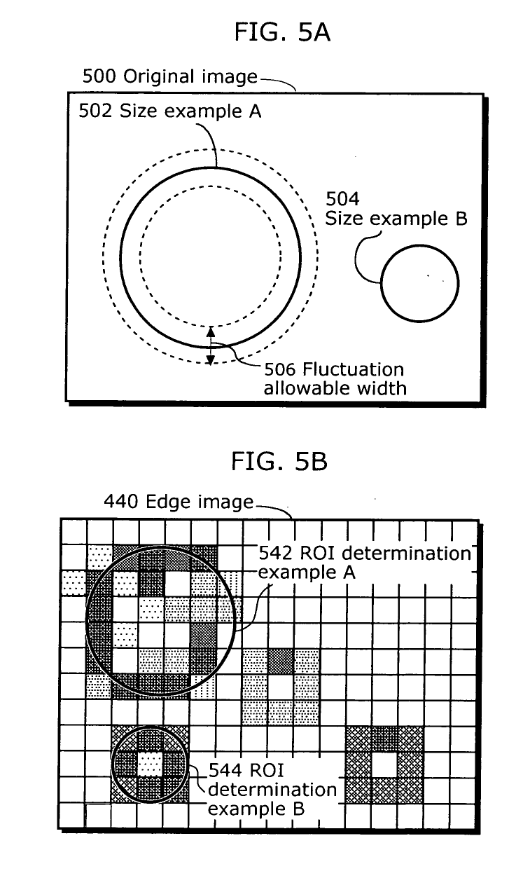

The shape designating unit 112 receives, from a user or the like, designations about the shape of the ROI to be extracted (e.g. round, rectangle and ellipse). The types of shape are not limited to the shapes described above, the shape designating unit 112 can receive designation of an arbitrary shape (FIG. 5A is an example where two round ROIs differing in size are specified from a user or the like as shapes for the ROIs to be extracted).

The size designating unit 114 receives designations about the size of the ROI (e.g. the absolute size determined by the number of pixels, the relative size described with the ratio of vertical and horizontal sizes of the image) from a user or the like. Other than designations by size, the size designating unit 114 may receive a designation of “the ratio to the size of the largest extractable ROI”, and may receive designation attributes such as “the second largest region” and “the largest region included in a specific size” as a replacement of size. In this case, the size itself can be dynamically changed depending on the content of the image (see FIG. 5A).

A size of the shape, including a shape which is dynamically changeable or unchangeable in size depending on the content of the image, may be specified by an arbitrary designating method, without being limited to the aforementioned method.

The position range designating unit 116 receives designation for the position and range of the ROI to be extracted. For example, the position range designating unit 116 receives designations of an absolute position (an absolute point) determined by the number of pixels and a relative position (a relative point) expressed with the ratio of vertical and horizontal sizes of the image.

An arbitrary method can be used for designation of the number of points, the designation form and a utilizing method thereof (rules for extracting the ROI).

In other words, the number of points, the designation form and utilizing method thereof can be arbitrarily selected from designations such as to “provide the order of precedence in designating a plurality of points and perform extraction to include points with higher priority as long as possible” or to “extract the ROI as a region including a plurality of points”, not to mention the aforementioned designation of to “extract the ROI to always include the points designated in the case where the position of the ROI is designated by point”.

Furthermore, the number of designating (designable) points may be either one or more. Also, as a condition for extraction of the ROI, the condition can be “always including”, either all designated points or at least one designated point; or can be an ambiguous (best-effort type) condition such as to “include as long as possible”.

Also, not only is the designation of position by points received, but also the designation by range can be received. This case enables the size and number of the range and utilizing method thereof can be arbitrarily selected as is the case with designation by point. For example, the designation can be to “extract the ROI to include at least 20 percent of the designated range”, to “extract the ROI within the designated range” or to “extract the ROI to include 50 percent or more of at least one of the ranges, when more than one ranges are designated”. However, as is the case with designation by point, arbitrary methods using mathematical/statistical processing feasible for an operator in the technical standard at the time of the filing can be used. The arbitrary methods define the range by establishing the priority and adding weight based on the probability distribution of a range so as to extract the region with as higher probability as possible.

In addition, in a range setting method, the detailed designation of range from a user or the like (e.g. it receives a range designation through a mouse, pen) is received, and in the case where points are designated, the arbitrary existing user interface such as a method realizing an automatic setting for the predetermined range may be used.

The number designating unit 118 is also capable of designating the ROIs by combination with the condition of the number of the ROIs. The number of the designated points and their utilizing methods can be set arbitrarily along with the condition of the number of points to be extracted. For example, this arbitrary setting is to “extract the ROI to include at least one designated point”.

The number designating unit 118 receives a designation of the number of the ROIs to be extracted from a user or the like. As is the case with a point designating method explained below, the number of designating ROIs to be designated by the position range designating unit 116 can be one or more. Furthermore, the number and designated form of the designating ROIs and their utilizing methods (rules regarding extraction and utilization of the ROIs) can use an arbitrary case (FIG. 5A shows, as described below, an example of a case that two ROIs are designated).

In other words, the designating condition for extracting the ROIs can be arbitrary as follows: always extracting the designated number of ROIs (putting the priority on the output of the designated number of ROIs even when extraction is difficult); and as a best-effort type condition, outputting to realize the extraction of the designated number of ROIs as long as possible.

Although the conditions and instructions which are received via the shape designating unit 112, size designating unit 114, position designating unit 116 and number designating unit 118 are arbitrary conditions and the like, the ROIs shall be extracted by using at least one received condition.

Although, as described in the first embodiment, the image processing device includes the shape designating unit 112, the size designating unit 114, the position range designating unit 116 and the number designating unit 118 which are interfaces for receiving instructions from a user or the like, these units do not necessarily have the configuration described above. Conforming to the actual use condition, the configuration of this processing device may be simplified as an image processing device which is equipped only with interfaces necessary to input the required instructions.

Furthermore, other interfaces may be provided to additionally input elements to be designated corresponding to extraction of the ROIs other than shape, size position range and number.

For example, in the case of extracting a plurality of ROIs, the following interfaces can be provided: an interface capable of designating not to overlap the ROIs with each others, an interface capable of controlling the distance between the ROIs, and an interface capable of controlling size of the ROIs (in the case where a plurality of the ROIs are extracted, the interface is provided to “extract ROIs including one ROI which is larger than other ROIs”, or to “extract all ROIs with almost identical size”). Needless to say, providing an interface for additionally inputting elements to be designated is not limited in the case described above, an interface capable of receiving an arbitrary designation within a range, in which extraction of the ROIs can be controlled, may be provided.

Next, a method for calculating a localized attractiveness in the image necessary to extract the ROI from the image shall be explained below.

The attractiveness is calculated by the attractiveness calculating unit 122 and the image processing unit for calculating the attractiveness 124. The attractiveness calculating unit 122 calculates the localized attractiveness in the image. The image processing unit for calculating the attractiveness 124 performs image processing necessary for the attractiveness calculation performed by the attractiveness calculating unit 122.

Conventional methods for extracting the ROIs and a human gaze model can be used for image processing performed by the image processing unit for calculating the attractiveness 124. For example, a method to calculate the localized attractiveness (a human gaze model) in the image is described in the aforementioned conventional technologies. In each of these technologies, a gazing model is constructed based on localized differences in the image.

When methods of the aforementioned conventional technologies are applied to the attractiveness calculating unit 122 and the image processing unit for calculating the attractiveness 124, the process for calculating the attractiveness using a gazing model (formula) corresponds to the attractiveness calculating unit 122, and image processing processes including difference processing correspond to the image processing unit for calculating the attractiveness 124.

In addition, with regard to methods to extract the ROI, there is a method for defining a localized “attractiveness” of the image, as is the case with the aforementioned conventional technologies. In these examples, the final “attractiveness” is calculated by breaking down the image (as an image pyramidal structure) by many levels of resolution (hereinafter called “high resolution”), by calculating differences in the brightness distribution of each level of resolution and hue difference between a current block and the adjacent block, by summing the calculated attractivenesses of each level of resolution with a predetermined weight, and by adding the weight based on the position.

As such, the image processing unit for calculating the attractiveness 124 has multi-resolution breaking down and hue converting functions. The calculation performance of the attractiveness can be improved by integrating (i) common filtering techniques such as noise reduction, normalization (a histogram equalizer, adjustment of dynamic range and the like), smoothing (gradation, low-pass filtering, Gaussian filtering and the like) and edge emphasis, and (ii) already available image processing technologies such as morphology conversion by OPENING and CLOSING. Specifically, noise reduction through filtering or morphology conversion is effective for preventing the attractiveness of an isolated noise from being too high. Furthermore, a smoothing processing is a process also leading to a scale space in the aforementioned conventional technologies, and is substitutable to a method, with which a scale space is defined and calculated to individual elements (individual pixels and blocks) in the image, by applying a Gaussian filter to the entire image.

The attractiveness calculating unit 122 calculates the attractiveness of each layer in each resolution, and calculates the final attractiveness according to weighting of the calculation value of each layer.

Also, as an ROI extraction method, not only a process of un-specifying the target as described above (e.g. a method to generally process the image), but also a process with which the target is specified as in the conventional technologies may be used. In the aforementioned conventional technologies, a brain region is extracted as an ROI from an MRI image.

Furthermore, detection, determination and recognition techniques including human and face detection, and character recognition, as well as detection and recognition of general objects, which are performed generally by using templates, neural networks, BOOSTING and the like can be used as an extracting method of ROI.

In such target predetermined processing methods (rule based type/template type processing), the probability of the target is calculated by internally performing matching and determination processing in general detection and recognition of the target. In the case where the probability is greater than the predetermined value, it is considered that the target is detected. The same is applied to target recognition.

The calculation of the target “probability” in these arbitrary rule based detection methods can be used in calculation of the attractiveness. Furthermore, the attractiveness can be calculated by multiplying the probability by coefficients corresponding to the types of the target. For example, the difference of the attractiveness to the target may be expressed by coefficients as follows: a coefficient “2.0” for a face; a coefficient “1.0” for a flower; and a coefficient “1.5” for a dog.

Note that, in the field of the aforementioned conventional technologies, a rule base type processing with which some kinds of information regarding the target are considered to be known is differentiated from a processing method with which the information regarding the content of the image and the target are not known, by calling the former “top-down type” and the latter “bottom-up type”.

Next, the function of the status displaying unit 132 is explained.

The status displaying unit 132 represents to a user the processing status and the condition setting status of the attractiveness calculating unit 122, the image processing unit for calculating the attractiveness 124 and the after-mentioned region forming condition setting unit 142. For example, the status displaying unit 132 represents each status to a user through an arbitrary unit such as a liquid crystal panel and a light-emitting diode (LED).

For example, the image processing results obtained by the image processing unit for calculating the attractiveness 124 can be displayed. Also, “the attractiveness” of each region of the image calculated by the attractiveness calculating unit 122 can be processed and displayed so as to be visible.

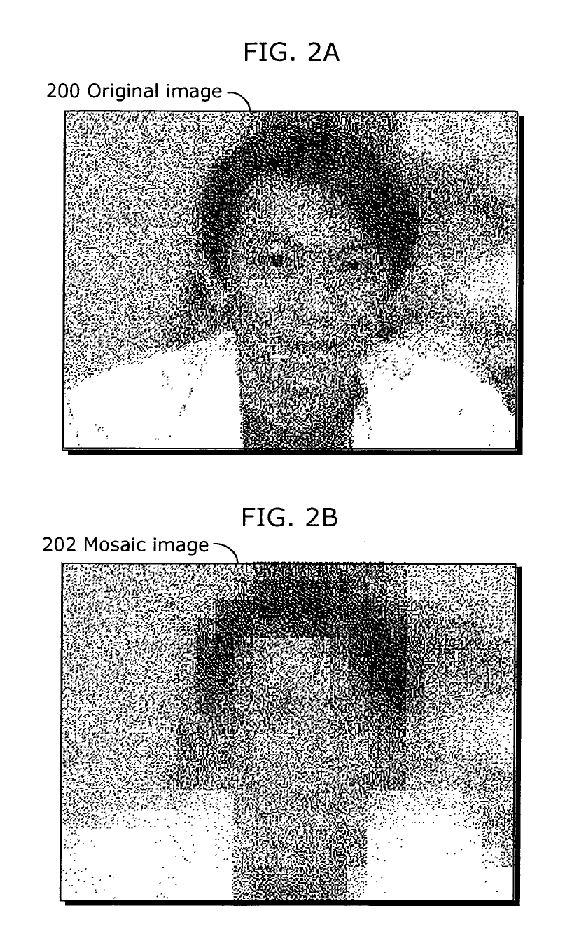

For example, FIG. 2 schematically shows the mosaic image 202 as an example of an image undergone multi-resolution conversion in the original image 200 and the image processing unit for calculating the attractiveness 124 (although each block of the original image 200 and the mosaic image 202 has a gradation value under ordinary circumstances, it is noted that FIG. 2 here shows binary black/white gradation represented virtually through the dither error diffusion. The same is applied to image examples described below).

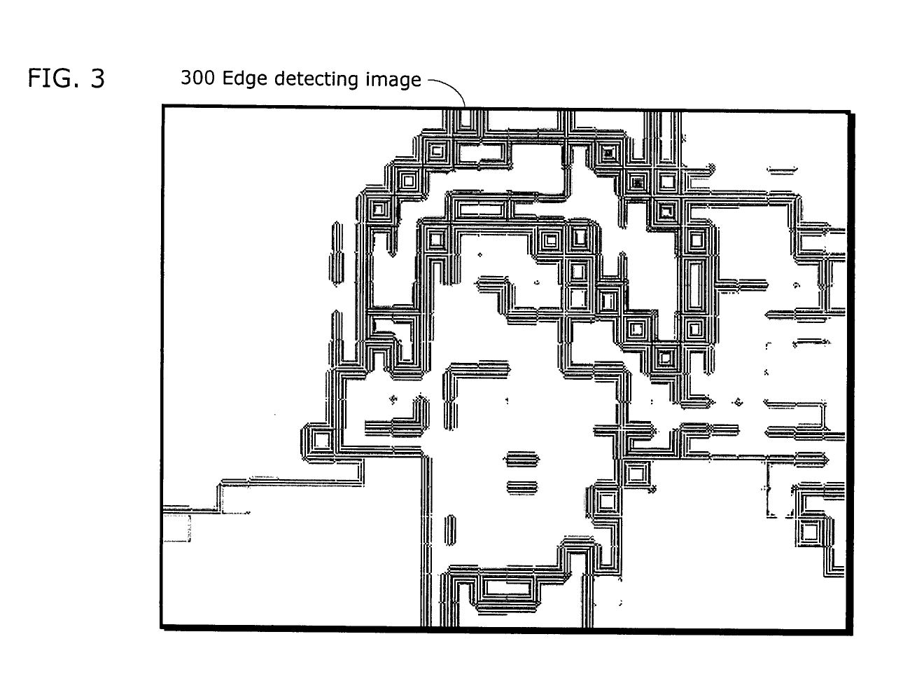

The case where “the attractiveness” is defined by using the strength of an edge alone is explained here (although the attractiveness can certainly be calculated through diverse methods as described above, a simple example is used here). In addition, in order to simplify the explanation, the strength of an edge is represented by a line-segment density. FIG. 3 shows an example of an image, which has been undergone edge detection. (Although, it is desirable in nature that the attractiveness is represented with gradation, the example is schematically shown as in FIG. 3 because such representation is infeasible with a binary drawing). The status displaying unit 132 displays the mosaic image 202 in FIG. 2B and the edge detecting image 300 in FIG. 3. This allows a user to know the image processing status and the distribution of the attractiveness.

It is noted that the status displaying unit 132, as is the case with each designating unit (the size designating unit 114, the position range designating unit 116, the number designating unit 118 and the like), is not an essential constituent element in the first embodiment. It is a constituent element which can be selected in accordance with necessity.

Next, the functions of the region forming condition setting unit 142 and the region forming unit 144 are explained. The region forming unit 144 determines the ROI based on the attractiveness as described above. The region forming condition setting unit 142 designates the determining condition herein.

When the region forming condition setting unit 142 sets the ROI determining condition, the condition is set based on instructions of a user or the like from each designating unit (the shape designating unit 112, the size designating unit 114, the position range designating unit 116 and the number designating unit 118).

In the case where the shape of the ROI is designated in the shape designating unit 112, the ROI determining condition is set so that the ROI is formed into the designated shape. In the case where the size of the ROI is designated by the size designating unit 112, the ROI determining condition is set to make the ROI be the designated size. In the case where the number of the ROI is designated by the number designating unit 118, the ROI determining condition is set to create the designated number of the ROIs. The details are explained below.

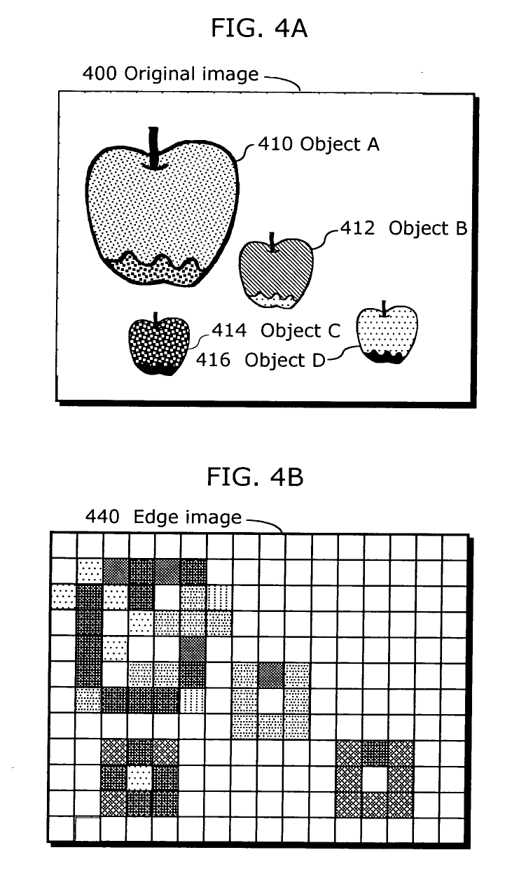

FIG. 4A is a diagram showing an example of an original image. FIG. 4A is a diagram schematically showing a state in which an object A410, an object B412, an object C414 and an object D416 are captured in an original image 400.

FIG. 4B schematically shows an example in which mosaic processing and edge extraction have been performed on the original image 400 as an edge image 440. As a matter of convenience, FIG. 4B, as is the case with the aforementioned example, shows the strength of the edge conforming to the degree of gradation of each block in the edge image 440.

Here, it is assumed that a round shape and a predetermined size are designated as the shape of the ROI by the shape designating unit 112 and as the size of the ROI by the size designating unit 114, respectively. For example, as shown in FIG. 5A, two circles are designated: a circle with the length of diameter approximately half the width of the original image 500, and a circle with the length of diameter approximately one fourth of the width of the original image 500. Furthermore, it is assumed that “two” is designated as the number of the ROIs by the number designating unit 118. In the original image 500, a size example A 502 and a size example B 504 are the conditions to determine the ROIs which have been designated by the shape designating unit 112, the size designating unit 114 and the number designating unit 118. That is, the condition described here is to “extract respective two round ROIs roughly in size shown in FIG. 5A”. Under this condition, the range for allowable variation of the size (of the size example A 502, in this case) may be set as a variation allowable width 506 shown in broken lines in FIG. 5A. It is noted that the presence or absence of the variation allowable width 506, the specific length of diameter and the like may be defined in a predetermined setting, and may be received by a user or the like through each designating unit (in the aforementioned example, the setting is ±20 percent of the diameter of the size example A 502).

The region forming condition setting unit 142 thus sets the condition for determining the ROI based on the designation from respective designating units.

The region forming unit 144 extracts the ROI corresponding to the size example A 502 and the size example B 504. The detailed example of extraction of a region corresponding to the size example A 502 is explained using FIG. 5B.

To simplify the explanation, the edge strength in the edge image 440 (in FIG. 5B, the darker the color of each block, the higher the edge strength) shall be directly applicable to the attractiveness. In other words, the edge image 440 is the attractiveness map that shows intensity of the attractiveness. In the explanation particularly using the attractiveness, the edge image 440 is hereafter called an attractiveness map 440.

It is noted that, as described in FIG. 5B, the size example A 502 with a variation allowable width 506 is scanned as in pattern matching, in the attractiveness map 440. This is equivalent to searching the position at which the sum of the attractiveness on the circle (the score of the attractiveness) is the largest (highest). A slightly different focus here from general pattern matching is that the attractiveness within the circle does not contribute to the score of the attractiveness, and the attractiveness of blocks on the circumference alone contributes to the score of the attractiveness. It is obvious that a general pattern matching algorithm may be directly applied to the scanning. However, since this leads to overestimate of the attractiveness inside the ROI rather than on the border of the ROI and could affect the quality of the output of the ROI (whether objects are appropriately arranged in the ROI), it is necessary to perform tuning by adding weight based on the distance from the contour line when using attractivenesses in a block on the border of the ROI and in a block inside the ROI as scores of the attractiveness.

The ROI obtained by scanning in the attractiveness map 440 by the size example A 502 so as to make the score of the attractiveness maximum as in pattern matching is the ROI determination example A 542 shown in FIG. 5B. Similarly, the ROI corresponding to the size example B 504 is the ROI determining example B 544 shown in FIG. 5B. When there is no specification of “round shape”, the shape can be altered into an ellipse and the like.

Although the example described above was explained by using pattern matching-like methods alone, determination of a precise position of the ROI and determination of a position involving shape change of the ROI itself are feasible by a method other than the pattern matching-like methods.

For example, a dynamic contour line extraction technology represented by SNAKES can be applied. The dynamic contour line extraction technology aims at extracting contour lines, and is a method of altering the contour line by defining the energy of the contour line so that the energy of the contour line is minimum in an image. This is an extraction method performed by using a typical energy converging calculation.

In the example of a pattern matching-like method, although matching was performed so that the score of the attractiveness reaches the maximum, the dynamic contour line extraction technology is applicable by reading “contour line energy” in the dynamic contour line extraction technology as “the score of the attractiveness”, and by performing an energy converging calculation in order to minimize the score of the attractiveness instead of maximize it. (Positive/negative inversion of the score of the attractiveness is performed to gain energy).

In the dynamic contour line extraction technology, the control points of predetermined number (e.g. 20 points) are arranged on the contour line, and a candidate point which can be a moving and transforming destination candidate is set corresponding to each control point. Energy is calculated in the case where each control point is moved to one of the candidate points, and the energy converging calculation is performed by deciding the candidate points with a minimum energy value as the next control points.

Here, as the after-mentioned example in which a round shape is designated for the shape of the ROI by the shape designating unit 112, in the case where the shape is designated, the following methods can be used: (i) a designing method to take a maximum value when energy itself is other than “round shape”; and (ii) a method to correct the shape into a round shape when convergence is finished. Such an energy defining process may also be performed by the region forming condition setting unit 142.

It is obvious that the constitution of the region forming condition setting unit 142 and the region forming unit 144 shall not be limited to the aforementioned example, and these unit can be constituted by using other existing technologies.

While, in the example shown in FIG. 5, two ROIs (an ROI determination example A 524 and an ROI determination B 544) are extracted without overlapping each other, there is also a case where decision of whether or not the ROIs are overlapped each other is necessary when extracting a plurality of ROIs. These examples include: the case whether or not each designating unit receives an overlap is designated; and the case where this image processing device 100 is preset so as not to receive an overlap.

Although whether or not the ROIs are overlapped each others can be easily realized by the existing technologies, another problem as to which objects should be grouped to preferentially being outputted as an ROI arises. Even though a method to automatically “extract a position with the highest score of the attractiveness from the entire image in the first ROI” and then to “extract a position with the highest score of the attractiveness from the remaining region” is receivable, the output shall be performed in the manner closer to a request from a user.

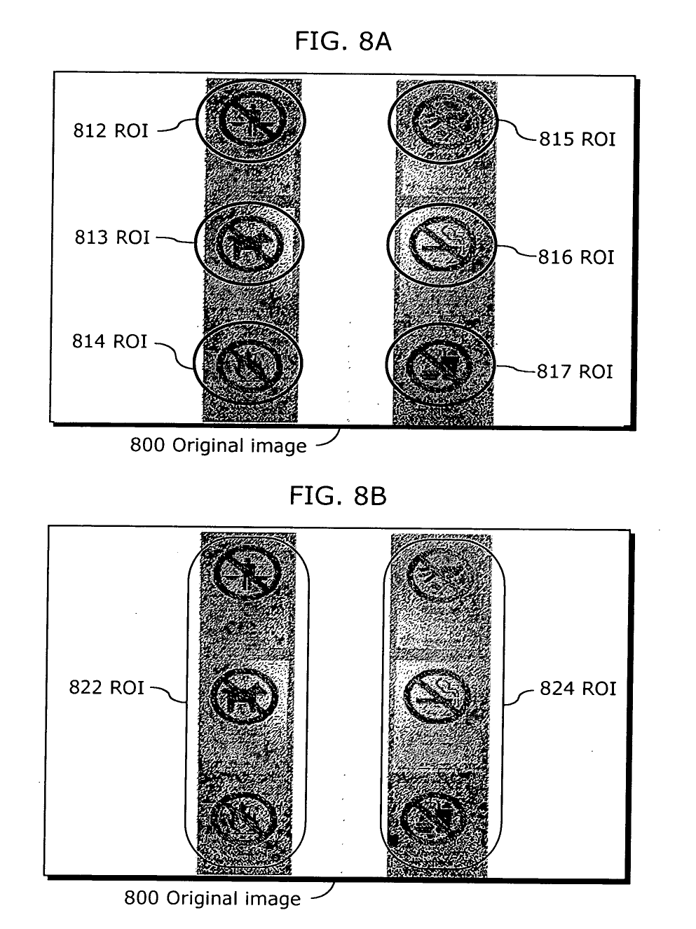

An image as described in FIG. 8A and FIG. 8B shall be considered as specific cases. One is the case where the number designating unit 118 designates “six” and “two” as the number of ROIs to be extracted. In this case, when the ROIs are simply selected in descending order of the attractiveness, an ROI 822 and an ROI 824 are firstly selected as ROIs to be selected as generally shown in FIG. 8B.

Although it is obvious that other regions can be selected as ROIs depending on a calculation method and a selecting method of the attractiveness, the attractiveness here is calculated based on an after-mentioned edge strength. Also, in the case where there is a region missing a texture inside the ROI, the region is designed to lower the score of the attractiveness as an ROI (in other words, it is designed not to extract a region between the ROI 822 and the ROI 824 as an ROI nor to extract a larger region that includes the ROI 822 and the ROI 824 as an ROI).

The case where the number of the ROIs to be extracted is designated as two by the number designating unit 118 has no particular problem, and the ROI 822 and the ROI 824 may be outputted as the ROIs.

However, when the number of the ROIs to be extracted is designated as “six” and the setting is made so as to unoverlap the ROIs with each others, the remaining four ROIs are to be selected mainly from the relatively insignificant (subjectively meaningless from a human's point of view) white region.

In order to “aim at an output closer to the subjectivity of a person (closer to a request from a user)”, it is obvious in this example that, when “six” is designated as the number, outputting an ROI 812, an ROI 813, an ROI 814, an ROI 815, an ROI 816 and an ROI 817 (hereinafter referred to as “six regions”) as described in FIG. 8A is better than extracting the ROI 822 and the ROI 824 as the first “two” ROIs.

Here, in the case where “six” is designated, it is more effective when the attractiveness is considered hierarchically in order to extract six regions. This can be considered as the same idea as the example of the multi-resolution decomposition of the image shown in the aforementioned explanation of the attractiveness calculation.

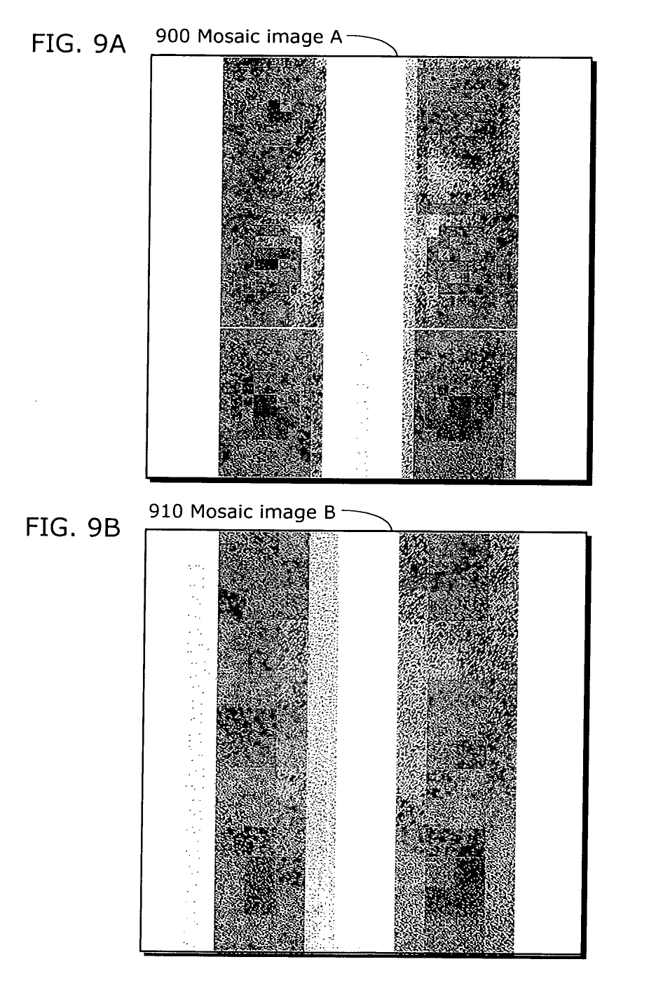

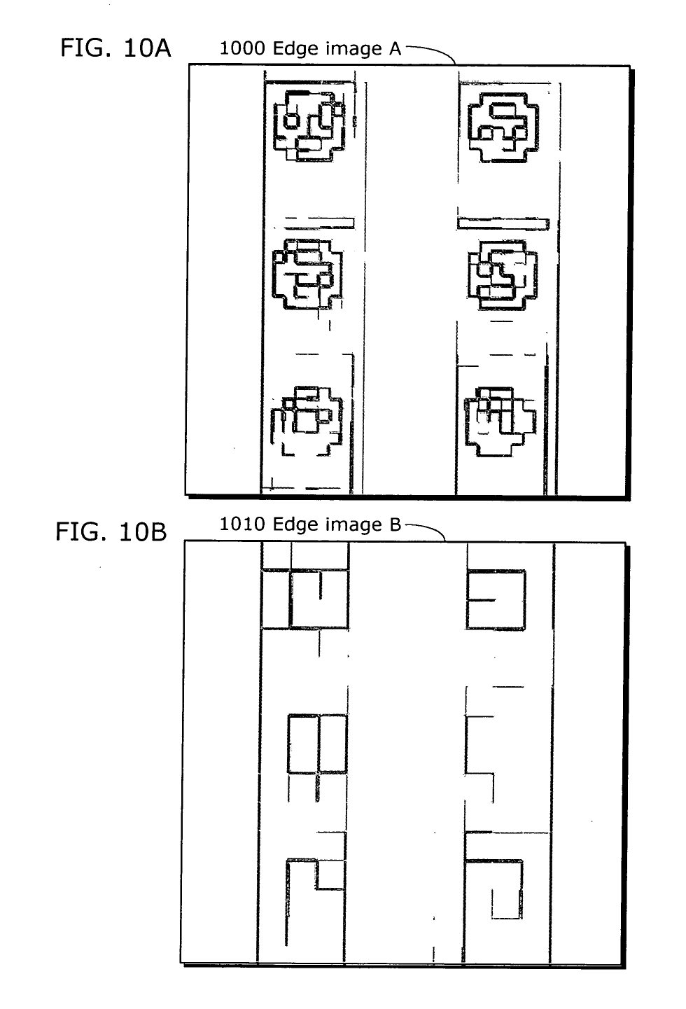

FIG. 9A and FIG. 9B are diagrams showing examples that the original image 800 in FIG. 8 is mosaicked in two levels of block size. Needless to say, these examples are schematic examples of multi-resolution decomposition of the original image 800. FIG. 10A and FIG. 10B are images represented by a plurality of pieces of resolution and undergone edge strength calculation, as a mosaic image A 900 in FIG. 9A and a mosaic image B 910 in FIG. 9B. As in FIG. 3, the edge strength is represented by a line-segment density for convenience. Comparison between an edge image A 1000 and an edge image B 1010 reveals that the edge image B 1010 captures wider distribution of edges, the edge image A 1000 captures more localized distribution of edges.

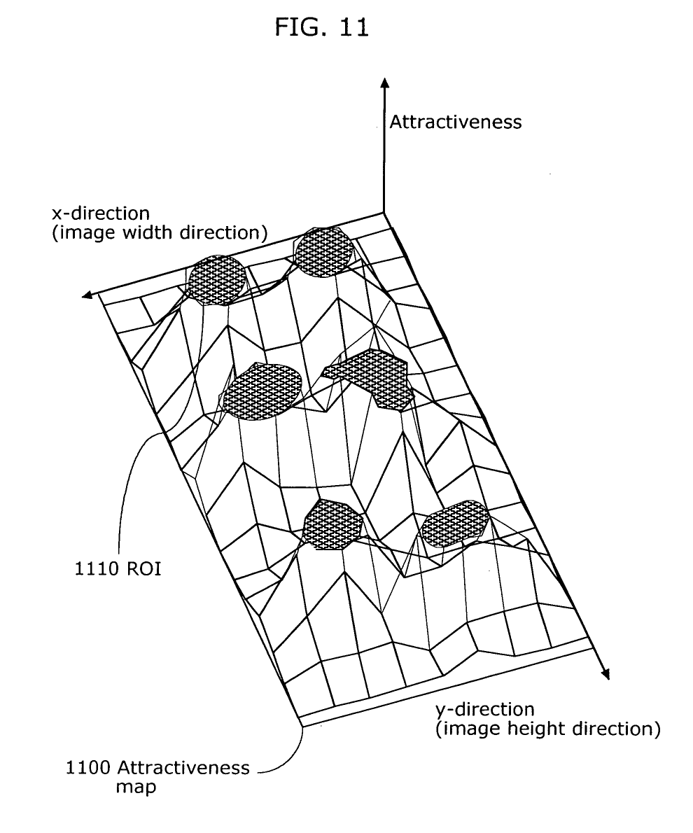

FIG. 11 shows an example of an attractiveness map which is generated by successively calculating the edge strength through multi-resolution and reading the edge strength as the attractiveness as in the examples above.

FIG. 11 schematically represents an attractiveness map (an attractiveness map 1100) in the case where the original image 800 is broken down into a plurality of multi-resolution representations, the edge strength is determined for each resolution and the edge strength is read as the attractiveness.

The height direction here represents the height of the attractiveness.

The attractiveness map 1100 is shown being cross-sectioned according to a predetermined value (an attractiveness) just like cross-sectioning a map using a contour line. Black portions in the attractiveness map 1100 represent cross-sectioned regions.

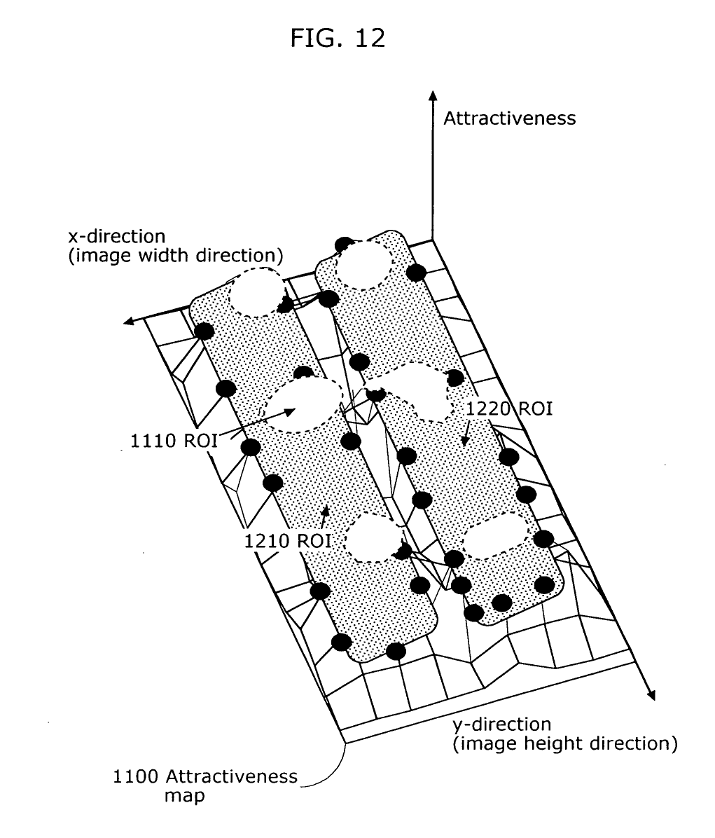

Here, the attractiveness map 1100 in FIG. 11 has six cross-sectioned regions. One of them is an ROI 1110. FIG. 12 shows an example that a height, at which the cross-sectioning is performed, has been changed. An attractiveness map 1200 in FIG. 12 is cross-sectioned at a lower height than that in FIG. 11. For convenience, main cross sections are represented as black dots. In addition, the cross sections (including the ROI 1110) created in FIG. 11 is represented by the regions circled with dotted lines in FIG. 12 for reference.

A focus on the fact that the attractiveness map 1100 and the attractiveness map 1200 are identical reveals that the number of the regions to be extracted as the ROIs can be changed by changing the height of cross-sectioning and observing the cross-sections.

Higher regions (regions with higher attractiveness) is more capable of outputting regions conforming to a request from a user as an ROI by hierarchically forming attention region candidates to be included in a lower and broader region. Naturally, there may be a case where a region corresponding to the ROI 1110 cannot be specifically extracted. In other words, in performing hierarchical cross-sectioning on the attractiveness map from highest level, there is a case in which it is difficult to determine which points constitute a region. In such a condition, the accuracy of a decision can be increased by adopting existing clustering methods (e.g. hierarchical methods such as a nearest neighbor method, and partitioning-optimization such as a k-means method) and discrimination methods such as a BOOSTING method. Also, an object may be extracted from the image by an existing template matching (this does not have to be a complete object extraction but can be object extraction only showing the approximate position and rough shape), and the result can be used for clustering of the attractiveness.

The explanation so far includes the explanation for an attractiveness map and a clustering method using an attractiveness map. However, the attractiveness map may be formed by the attractiveness map unit 148. Furthermore, clustering may be performed by the clustering unit 146.

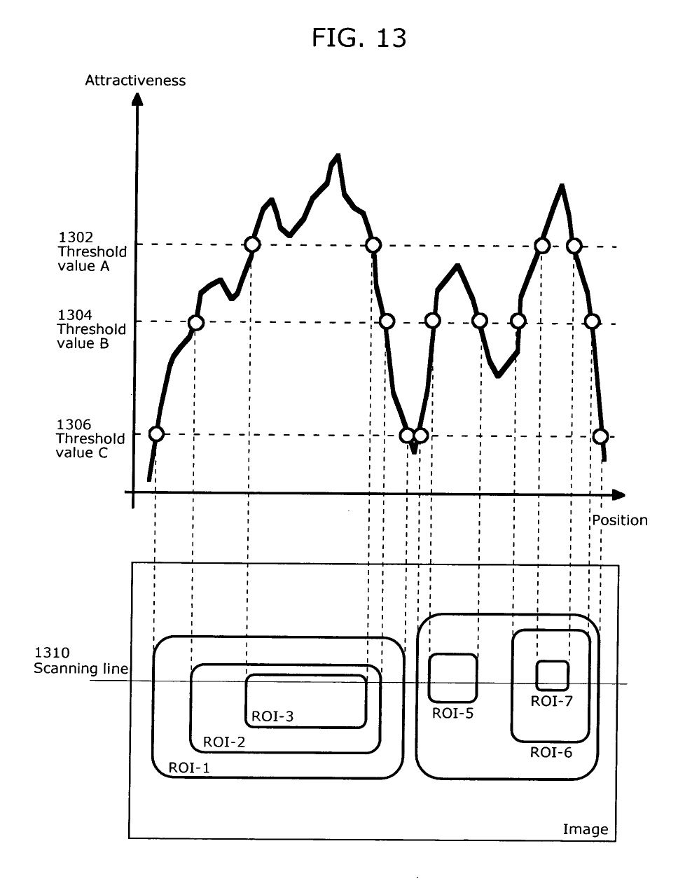

FIG. 13 is a diagram illustrating the simplified relationship between the threshold values (cross-sections) and the attractiveness maps in FIG. 11 and FIG. 12 as an operation of a threshold value determining unit 147.

FIG. 13 schematically shows the change of the attractiveness in the case where a scanning line 1310 cuts across the image. FIG. 13 also shows a case where a respective ROI is extracted at a threshold value A 1302, a threshold value B 1304, and a threshold value C 1306. Changing the threshold value facilitates a region more conforming to instructions regarding size and shape of the ROI from a user or the like to be extracted without changing the calculation formula of the attractiveness.

Also, it is possible to translate that clusters are constituted according to the attractiveness corresponding to each ROI which is formed respectively by using the threshold value A 1302, the threshold value B 1304, and the threshold value C 1306 in FIG. 13. The threshold value A 1302 can specify the following total five clusters: two clusters with attractivenesses higher than the threshold value A 1302; three clusters with attractivenesses lower than the threshold value A 1302 (in the image example, the left outside region of the ROI-3, the region from right outside of the border of the ROI-3 to the left outside of border of the ROI-7, and the right outside region of the ROI-7). It is obvious that the attractiveness may be divided into clusters by not only simply changing the threshold value, but also by using the aforementioned clustering method.

Furthermore, at this time, by performing clustering for multiple times (for example, by performing clustering at the threshold value A 1302 and at the threshold value B 1304), either a resulted region of a logical sum or of a logical product between a region and another region, on which clustering is performed, may be selected as an ROI. Every clustering method in the multiple-time clustering can be different from each other.

The processes so far described are conditions for deciding the ROI and an example of forming the ROI in the cases where the shape of the ROI is designated by the shape designating unit 112, the size of the ROI is designated by the size designating unit 114, and the number of the ROI is designated by the number designating unit 118.

Similarly, in the case where the position of the ROI is designated by the position range designating unit 116, the ROI determining condition is set to place the ROI at the designated position or to extract the ROI with additional weight according to the distance from that position.

This is also explained with examples below.

Here, the case in which the position of the center of the image is designated by a user or the like shall be considered. Since it is easy to extract an ROI so that the ROI always includes the designated position (in other words, it is receivable unless the ROI without the designated position is outputted), a method to extract the ROI located as closer as possible to the center of the image is explained in the following examples.

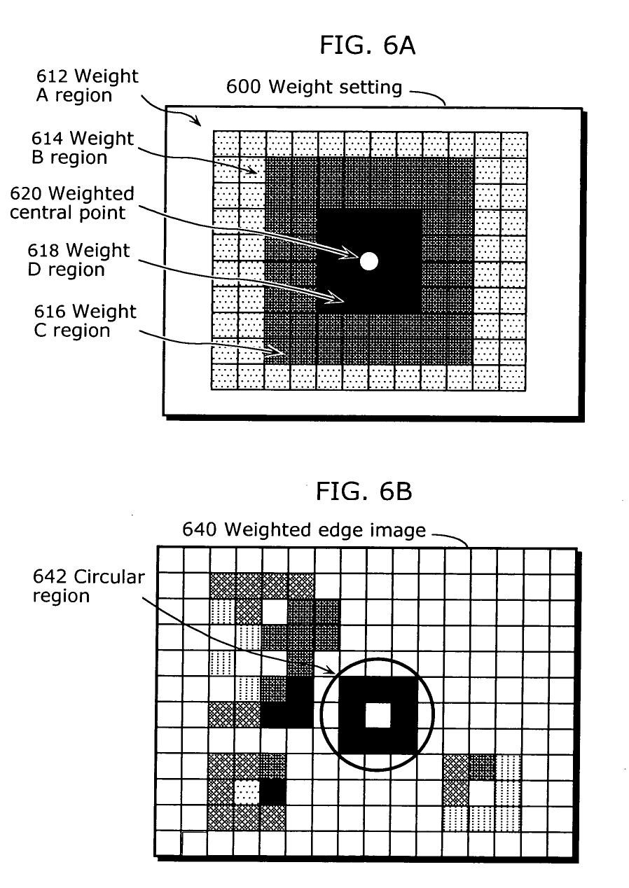

FIG. 6A is a diagram showing an example in which the weight corresponding to the attractiveness map is set. The example indicates that the darker the region is, the heavier the weight is. The combination of the weight setting and the attractiveness map enables the ROI to be extracted with a focus more on the center.

It is noted that the edge image 440 is read as the attractiveness map as explained in FIG. 4 and FIG. 5. A new attractiveness map created by combining the edge image 440 (the attractiveness map 440) with a weigh setting 600 is a weighted edge image 640 in FIG. 6B. Although schematically being shown, the weighted edge image 640 shows the edge (equivalent to the attractiveness) around the designated position (center) to be more emphasized and the edge (equivalent to the attractiveness) farther from the designated position to be less emphasized compared to the edge image 440 (the attractiveness map 440).

A circular region 642 is an example in which the ROI is decided in a pattern matching manner as in FIG. 5 in the weighted edge image 640. Needless to say that a region closer to the designated position (center) can be outputted as an ROI.

Next, the function of each output unit is explained below.

Each of an image output unit 152, a status output unit 154, and a region information output unit 156 includes, for example, a liquid crystal panel, and outputs a processed image, the processing status and the information of the ROI (the coordinates and size).

The status output unit 154 is also capable of outputting the processing status of each image being processed as a log in addition to the information as to whether or not the extraction of the ROI has been performed successfully. Each process in the present embodiment may be monitored as in the status displaying unit 132 or as a substitute for the status displaying unit 132.

It is noted that, like the designating units (e.g. the size designating unit 114), the image output unit 152 and the status output unit 154 are not essential constituents in the present embodiment. These two units are constituents which can be selected when necessary.

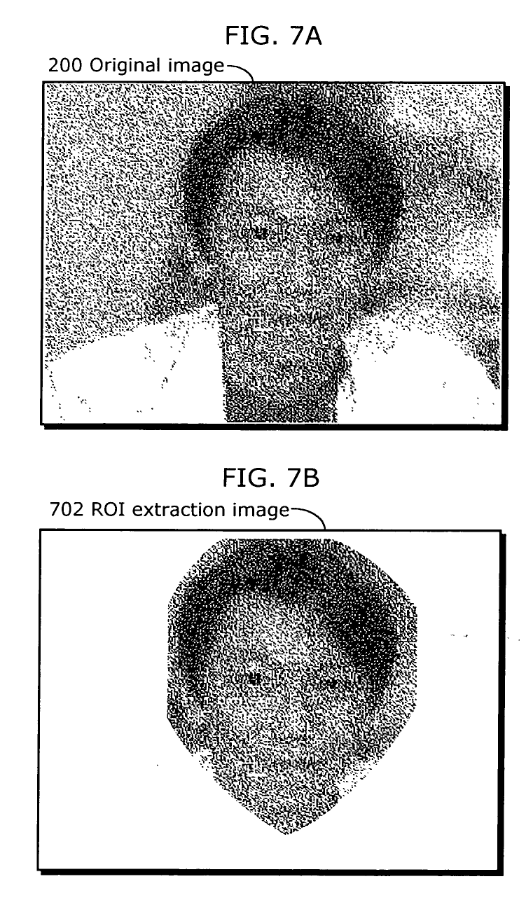

FIG. 7B is a diagram showing the result of the ROI extraction from an original image 200 (an ROI extraction image 702), as well as an example of an image outputted by the image output unit 152.

Next, the operation of the image processing device 100 according to the present invention is explained.

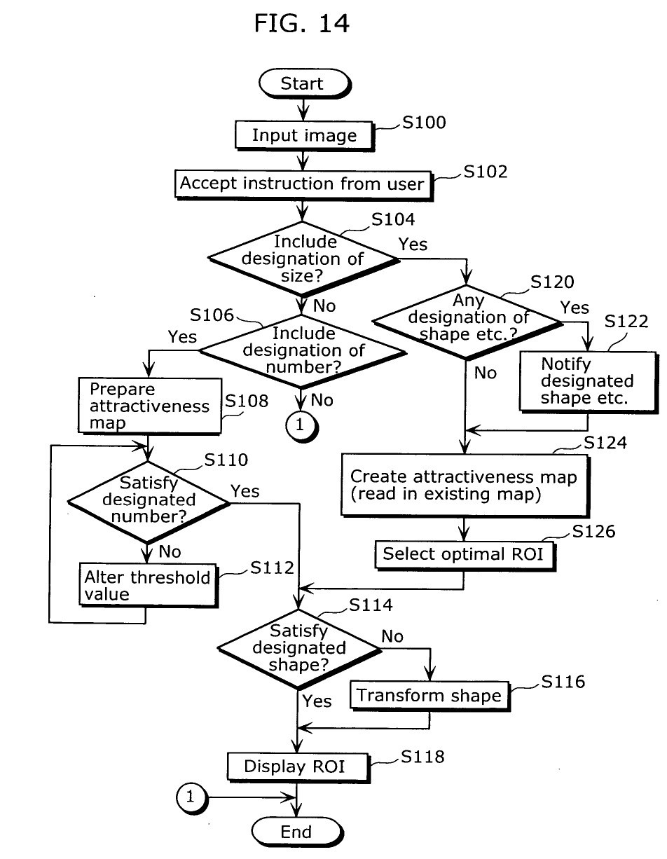

FIG. 14 is a flowchart showing a flow of processes in the image processing device 100.

First, an image is inputted via the image input unit 102 (S100), and an instruction from a user or the like is received via the shape designating unit 112, the size designating unit 114, the position range designating unit 116 and the number designating unit 118 (S102). Here, in the case where the designation for the size is included (S104: Yes) and there are designations including shape and the like (S120: Yes), the region forming condition setting unit 142 is notified of the designation (S122).

Next, the region forming unit 144 instructs the attractiveness map unit 148 to create an attractiveness map based on the aforementioned designating conditions (S124). Furthermore, the region forming unit 144 selects the optimal ROI by using a method similar to the conventional ones (S126).

Meanwhile, also in the case where the instructions from a user or the like include the number designation (S106), an attractiveness map is created (S108). In this case, when the created attractiveness map does not satisfy the condition of the designated number, the aforementioned process is repeated with a different predetermined threshold value (S110 and S112).

In addition, in the case where the shape designation is performed regarding the ROI specified above (S114), the ROI is transformed into the designated shape.

Lastly, the ROI specified in the aforementioned process is displayed (S118).

While in the explanation of the first embodiment the ROI is extracted from the entire image, the ROI may be extracted from a predetermined range or a designated range. An interface may also be prepared in order to designate the target range to be extracted.

In the explanation of FIG. 14, the presence of a number designating instruction is determined after the presence of a size designating instruction is determined in the S104. Other than this configuration, respective processes corresponding to the size designation, shape designation and number designation can be independently functioned, and relational dependence of each process (e.g. relationship between upstream and downstream in the flowchart) can be arbitrarily systematized according to the specification request and the like.

Other functions of the number designating unit 118 are additionally explained herein.

Other than the aforementioned method, the region to be outputted as an ROI may be determined based on each cluster in the case where clustering is performed changing the threshold value and the resulting number of the clusters satisfies the condition of the number. In this case, the number of pieces of data to be clustered (data distribution) itself changes by changing the threshold value. In the general data processing, that is, in the case where some kinds of significant features are to be analyzed from the predetermined data, it is meaningless to alter the very data to be analyzed. For example, if the population data is altered when statistic processing is performed, the meaning of the analysis itself is lost.

However, as in this case where the characteristics (ROI) in the image are to be extracted, distribution change of the data subjected to clustering for characteristics analysis bears the meaning. What is different from the general methods for optimization and improvement of efficiency of a clustering algorithm is that changing the input data distribution bears the meaning rather than clustering method itself.

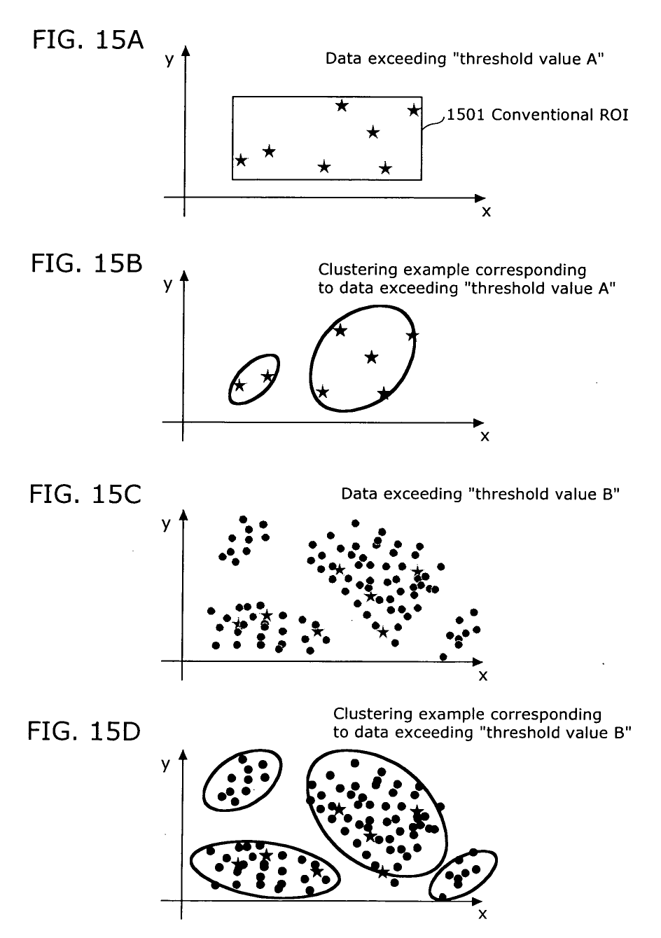

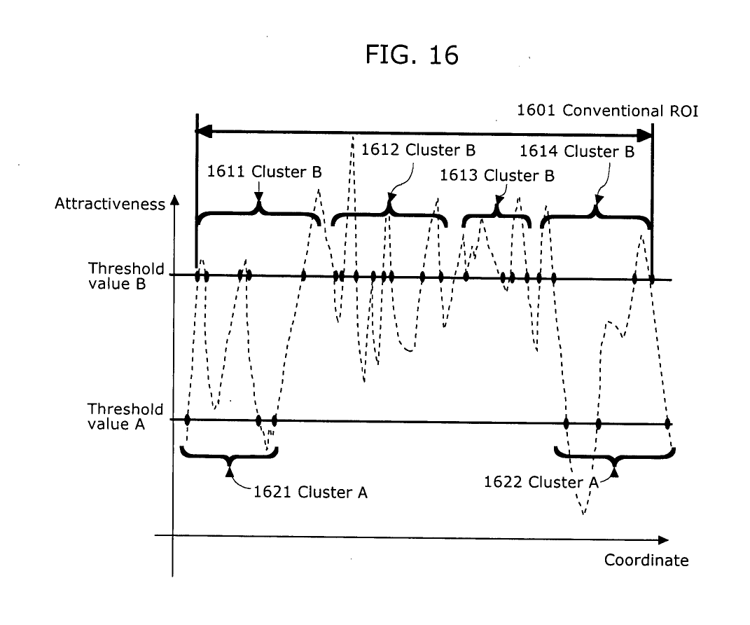

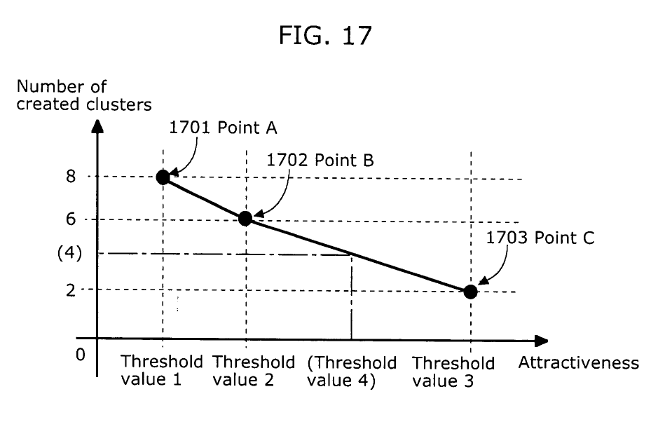

This is specifically explained below using FIG. 15, FIG. 16 and FIG. 17. The case where the extraction of four ROIs is designated is examined here as an instruction to be inputted. From FIG. 15A to FIG. 15D are schematic diagrams two-dimensionally showing relationships between distribution of data to be clustered, threshold values and the resulting clusters.

It is assumed that points of the attractiveness that exceed the threshold value A are scattered as described in FIG. 15A. In FIG. 15A, the coordinates, in which the image data with an attractiveness exceeding the threshold value A exists, are plotted with the horizontal axis defined as x direction (the width direction of the image) and the vertical axis defined as y direction (the height direction of the image). For example, a point A is defined as an attractiveness which corresponds to a pixel (x 1, y 1).

In the case where the distributed data as shown in FIG. 15A is clustered by using a general clustering method, the data is expected to be roughly classified into two clusters as shown in FIG. 15B. In methods of optimization and of improving efficiency in the conventional clustering methods, the main themes would be how to make the two regions optimal or how to classify the two regions into four. However, the present method enables the distribution of the image data itself to be altered by changing the threshold value.

FIG. 15C shows a distribution example of the image data in the case of changing the threshold value A into the threshold value B. It is assumed that the threshold value A is greater than the threshold value B. In FIG. 15C, star-shaped points represent the points with the attractiveness exceeding the threshold value A; and round points indicate the points with the attractiveness less than the threshold value A but greater than the threshold value B. If a general clustering method is used for the data in FIG. 15C, it is expected that the data is classified into four clusters as shown in FIG. 15D. As a result, the extraction of four ROIs is designated as an input instruction. In this case, the ROIs may be set from the data belonging to each cluster using the result of clustering at the threshold value B. The ROI to be outputted is for example an elliptic region surrounding each cluster in FIG. 15D.

FIG. 16 is a diagram one-dimensionally showing the relationship between the distribution of the attractiveness, the threshold value and the resulting clusters. The horizontal axis represents the coordinates (the image is one-dimensionally represented) and the vertical axis represents the attractiveness. In the graph of the attractiveness in FIG. 16, the black elliptic points represent points each of which has the attractiveness higher than the threshold value A or the threshold value B. In fact, the graph of the attractiveness is plotted with discrete values (discrete values per pixel).

In the image data of the threshold value A, only six pieces of data are obtained and only two clusters are created (a cluster A 1621 and a cluster A 1622). Four clusters from a cluster B 1611 to a cluster B 1614 are created at the threshold value B. FIG. 16 also shows a conventional ROI setting method for comparison. In the conventional ROI setting methods, in the case where attractivenesses exceed the predetermined value (in this case, the threshold value B), an ROI is defined as a region (e.g. rectangular region) including all points corresponding to these attractivenesses, the points either touching internally or not touching the outer line of the region. The one-dimensional description of this is represented by the conventional ROI (1601). The two-dimensional description of this is represented by the conventional ROI (1501) in FIG. 15A. The comparison between the conventional ROI (1601) shown in FIG. 16 and the result of clustering based on the threshold value A or the threshold value B reveals that in contrast to the standardized conventional ROI setting methods, the ROI can be extracted flexibly to the data distribution in the present invention. The distribution of the attractivenesses varies according to the image. For that reason, although the threshold value and the number of obtainable data and of clusters have no general regularity, repeating clustering a number of times can be less required by appropriately setting the threshold value.

In a hypothetical setting, eight clusters are created at a threshold value 1, six clusters are created at a threshold value 2, and two clusters are created at a threshold value 3 in a certain image. This can be represented by a graph in FIG. 17.

In the case where the extraction of “four” ROIs is designated as an inputted instruction, the presence of a “threshold value 4”, which is likely to create four clusters between the threshold value 2 and the threshold value 3, can be predicted (the prediction situation described above is indicated by a dashed line in FIG. 17). Since the attractiveness changes according to the content of the image, there is a high probability that the prediction described above becomes a reality except for the case where the content of the image is extremely specific, even though the threshold value 4 is not necessarily present.

The proper threshold value can be set by setting the threshold value 4 between the threshold value 2 and the threshold value 3.

### INDUSTRIAL APPLICABILITY

The image processing device according to the present invention presents a method to extract the ROIs from a single still image or a plurality of groups of still images and from a moving image, conforming to user's requests (shape, size and the number of the ROIs), and is applicable to an automatic image editing apparatus as well as to a system designed to store, control and classify images.

1. An image processing device comprising:
an image input unit operable to obtain image data representing an image;
an instruction input unit operable to receive a condition for extraction of a region of interest of the image;
an attractiveness calculating unit operable to calculate an attractiveness which indicates a degree of user's attention to the image;
a region forming unit operable to form a region of interest from the image based on a pixel which corresponds to an attractiveness exceeding a predetermined threshold value of the calculated attractiveness; and
a determining unit operable to determine whether or not the formed region of interest satisfies the received condition, wherein the threshold value is altered, and the processes of said region forming unit and said determining unit are repeated, in the case where it is determined that the condition is not satisfied.

2. The image processing device according to claim 1,
wherein said instruction input unit is operable to receive an instruction regarding the number of the regions of interest to be formed, and
said region forming unit is operable to perform clustering on the pixel which corresponds to the attractiveness exceeding a predetermined threshold value of the calculated attractiveness in the image so that the number of resulting clusters approximately matches the received number of the regions of interest, and to define a region which includes a cluster obtained by the clustering as the formed region of interest.

3. The image processing device according to claim 2,
wherein said region forming unit is further operable to perform a first clustering on a region in which the attractiveness of the obtained image satisfies a first condition; to perform a second clustering on a region in which the attractiveness of the image satisfies a second condition; to compare results of the first clustering and the second clustering; and to define a region, which includes at least a part of the region specified as a region of interest through the first clustering and is specified as the region of interest through the second clustering, as a region of interest.

4. The image processing device according to claim 3,
wherein said region forming unit is further operable to perform the first clustering or the second clustering by changing the first condition or the second condition respectively until the number of the regions of interest satisfies the number indicated by the instruction.

5. The image processing device according to claim 2,
wherein said region forming unit is operable to change the number of pieces of image data, which are subjected to the clustering, by altering the threshold value.

6. The image processing device according to claim 2,
wherein said region forming unit is further operable to alter the threshold value based on the number of the clusters resulting from the clustering.

7. The image processing device according to claim 6,
wherein, in the case where the number instructed by said instruction input unit is within a range of the number of the clusters when altering the threshold value, said region forming unit is operable to select a threshold value that corresponds to the number of the clusters within the range.

8. The image processing device according to claim 1,
wherein the obtained image includes an object,
said attractiveness calculating unit is operable to extract an object from the obtained image, and to calculate an attractiveness corresponding to the extracted object based on a predetermined calculation formula, and
said region forming unit is further operable to form the region of interest based on the calculated attractiveness.

9. The image processing device according to claim 8,
wherein said attractiveness calculating unit is further operable to hierarchically perform the object extraction n number of times, and to calculate an attractiveness corresponding to each extracted object based on a predetermined calculation formula, and
said region forming unit is further operable to determine a region of interest based on the calculated attractivenesses of the object extracted in n hierarchal levels.

10. The image processing device according to claim 1,
wherein said attractiveness calculating unit is operable to calculate an attractiveness on a predetermined unit block basis, and, in addition, to form an attractiveness map where the calculated attractiveness and the unit block are associated with each other, the unit block having n×m pixels, where n and m are positive integers, and
said region forming unit is operable to perform an interpolation processing as necessary on a position at which an attractiveness intersects a predetermined value, to obtain a candidate region that includes the unit block satisfying the predetermined value based on a set of the intersection positions, and to specify the candidate region as a region of interest.

11. The image processing device according to claim 1,
wherein said region forming unit is operable to form at least two regions of interest so that one of the following conditions is satisfied: a region of interest is not overlapped with an other region of interest; a region of interest includes an other region of interest; a region of interest has nearly the same size as an other region of interest; and each region of interest is different in size.

12. The image processing device according to claim 1,
wherein said instruction input unit is further operable to receive an instruction indicating a shape of the region of interest, and
said region forming unit is further operable to specify a region, in which at least one of a total sum of the attractivenesses and an average of the attractivenesses per pixel is a maximum value, by using a template roughly identical in size to the shape indicated in the instruction, in order to extract a region of interest in a shape roughly identical to the shape indicated in the received instruction, and to define the specified region as a region of interest.

13. The image processing device according to claim 12,
wherein in the case of specifying the region providing the maximum value, said region forming unit is further operable to obtain the maximum value using at least one of an attractiveness on a contour line of the template roughly identical in size to the shape indicated in the instruction and an attractiveness inside the contour line of the template roughly identical in size to the shape indicated in the instruction.

14. An integrated circuit comprising:
an image input unit operable to obtain image data indicating an image;
an instruction input unit operable to receive a condition with regard to an extraction of a region of interest of the image;
an attractiveness calculating unit operable to calculate an attractiveness which represents a degree of a user's attention in the image;
a region forming unit operable to form a region of interest from the image based on a pixel which corresponds to an attractiveness exceeding a predetermined threshold value in the calculated attractiveness; and
a determining unit operable to determine whether or not the formed region of interest satisfies the received condition,
wherein the threshold value is altered, and the processes of said region forming unit and said determining unit are repeated, in the case where it is determined that the condition is not satisfied.

15. An image processing method comprising:
an image input step of obtaining image data indicating an image;
an instruction input step of receiving a condition with regard to an extraction of a region of interest of the image;
an attractiveness calculating step of calculating an attractiveness which represents a degree of a user's attention in the image;
a region forming step of forming a region of interest from the image based on a pixel which corresponds to an attractiveness exceeding a predetermined threshold value in the calculated attractiveness; and
a determining step of determining whether or not the formed region of interest satisfies the received condition,
wherein the threshold value is altered, and the processes of said region forming step and said determining step are repeated, in the case where it is determined that the condition is not satisfied.

16. A program which is used for an image processing device and is executed by a computer, said program comprising:
an image input step of obtaining image data indicating an image;
an instruction input step of receiving a condition with regard to an extraction of a region of interest of the image;
an attractiveness calculating step of calculating an attractiveness which represents a degree of a user's attention in the image;
a region forming step of forming a region of interest from the image based on a pixel which corresponds to an attractiveness exceeding a predetermined threshold value in the calculated attractiveness; and
a determining step of determining whether or not the formed region of interest satisfies the received condition,
wherein the threshold value is altered, and the processes of said region forming step and said determining step are repeated, in the case where it is determined that the condition is not satisfied.
